(19) United States
(12) Patent Application Publication
(10) Pub. No.: US 2019/0236410 A1
(43) Pub. Date: Aug. 1, 2019

(54) BOOTSTRAPPING RECOMMENDATION SYSTEMS FROM PASSIVE DATA

(71) Applicant: ADOBE INC., SAN JOSE, CA (US)

(72) Inventors: Sorathan Chaturapruek, Stanford, CA (US); Georgios Theocharous, San Jose, CA (US)

(21) Appl. No.: 15/886,263

(22) Filed: Feb. 1, 2018

(51) Int. Cl. G06K 9/62; G06N 99/00; G06N 7/00

(52) U.S. Cl. CPC G06K 9/6256; G06K 9/6218; G06N 7/005; G06N 99/005

(57) ABSTRACT

Systems and methods provide for bootstrapping a sequential recommendation system from passive data. A learning agent of the sequential recommendations system is trained using the passive data over a number of epochs involving interactions between the sequential recommendation system and user devices. At each epoch, available active data from previous epochs is obtained, and transition probabilities are generated from the passive data and at least one parameter derived from the currently available active data. A recommended action is selected given a current state and the generated transition probabilities, and the active data is updated from the current epoch based on the recommended action and a resulting new state. A clustering approach can also be employed when deriving parameters from active data to balance model expressiveness and data sparsity.

### BACKGROUND

Recommendation is a fundamental problem that has gained utmost importance in the modern era of information overload. Generally, the goal of recommendation is to help a user find an item or perform an action given a large number of possible items or actions. Conventional recommendation systems typically provide one-time recommendations based on predictions made from static information. Sequential recommendation systems, on the other hand, provide a sequence of recommendations based on where each recommendation would lead a user to a different path with a particular goal in mind. Such sequential recommendation systems can be used in a variety of different contexts. As an example to illustrate, a sequential recommendation system could be used to sequentially recommend tutorials for a software application where a new tutorial is recommended to the user each time the user completes a tutorial in order to optimize subscription retention and user engagement for the software application. As another example, a sequential recommendation system could be used to sequentially recommend points of interest at a theme park in order to balance traffic and maximize user experience.

Reinforcement learning is one technique that shows promise for training sequential recommendation systems by having a learning agent learn from interactions with users. Reinforcement learning involves providing rewards (positive or negative) for recommended actions selected by the learning agent in response to user actions in order for the learning agent to learn an optimal policy that dictates what recommended actions should be selected given different system states, including previous user actions and learning agent recommendations. In this way, some forms of reinforcement learning are trained from active data—i.e., information regarding what actions users have taken given recommended actions from the learning agent. Unfortunately, active data is often not available, for instance, when deploying new sequential recommendations systems and the learning process is slow and inefficient.

### SUMMARY

Embodiments of the present invention relate to using passive data to bootstrap a sequential recommendation system to train a learning agent in a more efficient manner. Passive data includes information regarding sequences of user actions without any recommendation from a sequential recommendation system. For instance, the passive data can be collected before the sequential recommendation system is deployed. A learning agent of the sequential recommendations system is trained using the passive data over a number of epochs involving interactions between the sequential recommendation system and user devices. At each epoch, available active data from previous epochs is obtained. Transition probabilities used by the learning agent to select recommendations are generated from the passive data and at least one parameter derived from the currently available active data. A recommended action is selected given a current state and the generated transition probabilities, and the active data is updated from the epoch based on the recommended action and a new state resulting from an action selected by the user in response to the recommended action. Using the passive data in this manner allows the learning agent to more quickly and efficiently learn an optimal policy. In some configurations, a clustering approach is also employed when deriving parameters from the active data to balance model expressiveness and data sparsity when training the learning agent. The clustering approach allows model expressiveness to increase as more active data becomes available.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating an exemplary system in accordance with some implementations of the present disclosure;

FIG. 2 is a diagram illustrating exemplary linking functions suitable for deriving transition probabilities in accordance with some implementations of the present disclosure;

FIG. 3 is a diagram illustrating tradeoff between model expressiveness and data availability in accordance with some implementations of the present disclosure;

FIG. 4 is a diagram illustrating exemplary clustering to derive parameter values in accordance with some implementations of the present disclosure;

FIG. 5 is a flow diagram showing method for using passive data when training a learning agent to provide recommended actions in accordance with some implementations of the present disclosure;

FIG. 6 is a flow diagram showing a method for using a clustering approach to derive parameters used to generate transition probabilities in accordance with some implementations of the present disclosure; and

FIG. 7 is a block diagram of an exemplary computing environment suitable for use in implementations of the present disclosure.

### DETAILED DESCRIPTION

Sequential recommendation systems conventionally employ reinforcement learning to train a learning agent to provide recommendations. For instance, Markov decision processes (MDP) are often used as a model for sequential recommendation systems. Such reinforcement learning techniques involve training a learning agent from interactions with users. Generally, in each interaction with a user, referred to herein as an “epoch,” the learning agent selects a recommendation based on a current state and a transition model. The current state can be based on, for instance, previous user actions and recommended actions over a session with a user. A reward (positive or negative) is provided to the learning agent for each epoch that can be based on the recommended action and a new state resulting from a user action taken in response to the recommended action. In this way, the learning agent learns an optimal policy for selecting recommend actions.

The transition model used by the learning agent for selecting a recommended action at each epoch includes transition probabilities that each reflect the probability of a new state that would result from a current state if a particular recommended action is provided. The transition probabilities are conventionally derived from active data. Active data comprises historical information regarding what actions users have taken given recommended actions from the learning agent. A robust sequential recommendation system requires a large amount of active data to derive optimal transition probabilities. Unfortunately, only limited active data, if any at all, is available in many circumstances, for instance, when developing a new sequential recommendation system. Active data can be gathered through use of such sequential recommendation systems, but this could take an unreasonable amount of time for the learning agent to learn an optimal policy.

Embodiments of the present disclosure address the technical problem of having insufficient active data to train a learning agent of a sequential recommendation system by bootstrapping the sequential recommendation system from passive data. Passive data comprises historical information regarding sequences of user actions. However, unlike active data, passive data does not include information regarding recommended actions from a sequential recommendation system. For instance, take the example of a tutorial system that provides tutorials to teach users features of a software application. In the absence of any recommendation system, users can navigate from one tutorial to another. Information regarding the sequences of tutorials viewed by users could be available as passive data when developing a sequential recommendation system to recommend tutorials to users.

Because passive data includes sequences of user actions without recommendations, the data doesn't provide information regarding how users would react to recommendations. The passive data only provides information for deriving the probabilities of new states given current states, and as such cannot be used alone to derive transition probabilities that reflect the probabilities of new states given currents states and recommend actions. Accordingly, as will be described in further detail below, implementations of the technology described herein employ linking functions to bridge between the passive data and transition probabilities. The linking functions generate parameters from currently available active data, and transition probabilities are derived from the passive data and the parameters from the linking functions. At each epoch, additional active data is collected, and new transition probabilities can be generated based on the passive data and parameters derived from the currently available active data. By leveraging the passive data, the learning agent can learn an optimal policy more quickly when deploying a sequential recommendation system.

Some implementations of the present technology also employ an approach that balances model expressiveness and data availability. Model expressiveness reflects the variability in parameters used to generate transition probabilities. At one end of the spectrum, a single global parameter could be used for all combinations of states and actions. This provides an abundance of data for deriving the parameter but suffers from low model expressiveness. At the other end of the spectrum, a parameter could be used for each combination of states and actions. This provides high model expressiveness, but suffers from data sparsity. Some embodiments employ a clustering approach to provide a trade-off between the two extremes. As will be described in further detail below, the clustering approach involves generating a preliminary parameter value for each state and clustering states with similar parameter values. For each cluster, a shared parameter value is determined from preliminary parameter values of states in the cluster, and the shared parameter value is assigned to each of those states in the cluster. The number and size of clusters used can be adjusted to balance model expressiveness with data sparsity. This can include clustering based on confidence values associated with shared parameter values based on data availability.

Aspects of the technology disclosed herein provide a number of advantages over previous solutions. For instance, one previous approach involves a MDP-based recommendation system that assumes that the effect of recommending each action is fixed by some popularity measure and doesn't learn those parameters. However, assuming the effect of recommending an action has a significant drawback when the assumed value is biased. To avoid such bias, implementations of the technology described herein, for instance, systematically develop an algorithm to learn the correct causal effect of recommending an action while taking data sparsity into account. Some other previous work addressed the problem of data sparsity partially. The parameterization in this previous model, however, is less expressive, and thus it learns to optimize the objective more slowly due to a model bias. Another previous work studied the effect of recommending an action as compared to a system without recommendations. However, in that work, only one parameter is used for the impact of the recommendations. The algorithm used in that work doesn't use data availability to tradeoff with model expressiveness to further optimize the learning algorithm.

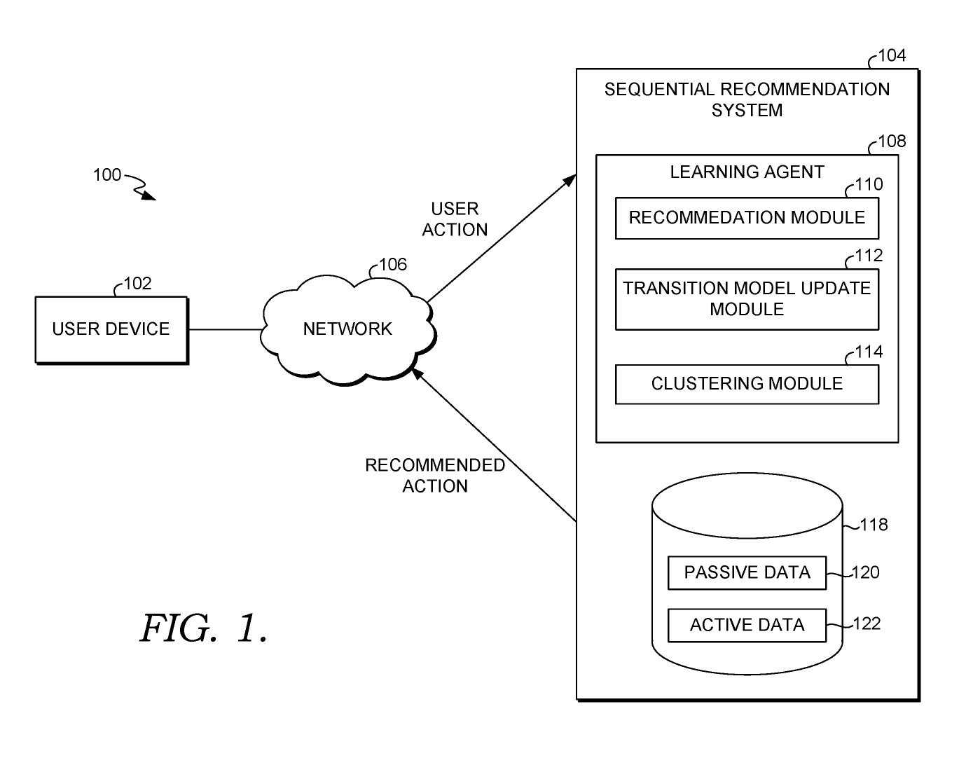

With reference now to the drawings, FIG. 1 is a block diagram illustrating an exemplary system 100 for using passive data 120 to train a learning agent 108 of a sequential recommendation system 104 to provide recommended actions in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

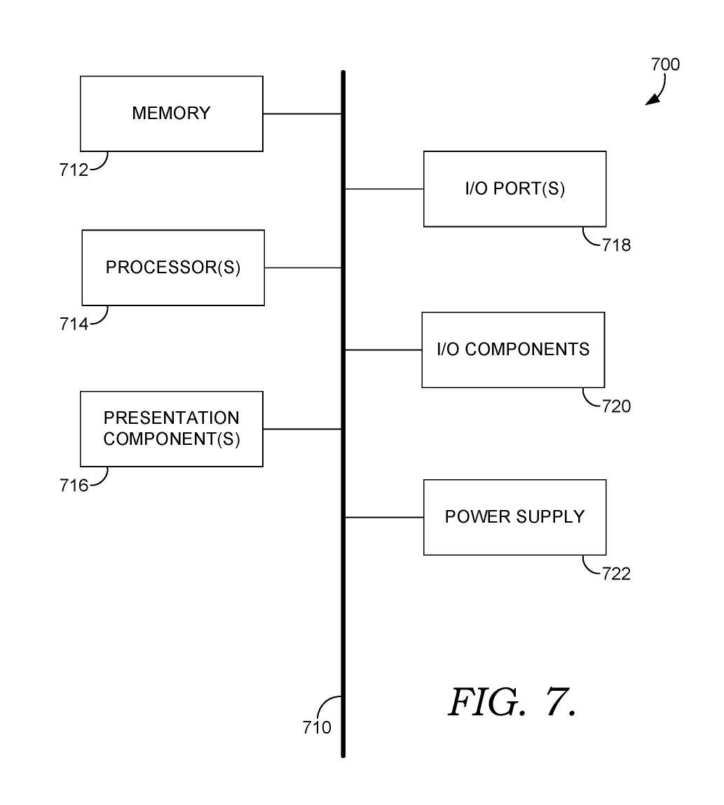

The system 100 is an example of a suitable architecture for implementing certain aspects of the present disclosure. Among other components not shown, the system 100 includes a user device 102 interacting with a sequential recommendation system 104 that is configured to iteratively provide recommended actions to the user device 102. Each of the components shown in FIG. 1 can be provided on one or more computing devices, such as the computing device 700 of FIG. 7, discussed below. As shown in FIG. 1, the user device 102 and the recommendation system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and recommendation systems may be employed within the system 100 within the scope of the present invention. Each may comprise a single device or multiple devices cooperating in a distributed environment. For instance, the sequential recommendation system 104 could be provided by multiple server devices collectively providing the functionality of the sequential recommendation system 104 as described herein. Additionally, other components not shown may also be included within the network environment.

The sequential recommendation system 104 is generally configured to provide recommended actions to user devices, such as the user device 102. This could be recommended actions within the context of any of a variety of different types of applications. The user device 102 can access and communicate with the sequential recommendation system 104 via a web browser or other application running on the user device 102 via the network 106. Alternatively, in other embodiments, the recommendation system 104 or portions thereof can be provided locally on the user device 102.

At a high level, the sequential recommendation system 104 includes a learning agent 108 that is trained to iteratively provide recommended actions to the user device 102 over epochs. For each epoch: the learning agent 108 provides a recommended action to the user device 102 based on a current state; information is returned regarding a user action taken after providing the recommended action; a new state is derived based at least in part on the recommended action and user action; and a reward is provided for training the learning agent 108. The learning agent 108 uses such information to improve its recommendation algorithm at each epoch. While only a single user device 102 is shown in FIG. 1, it should be understood that the learning agent 108 may be trained by interactions with any number of user devices.

The learning agent 108 includes a recommendation module 110, a transition model update module 112, and a clustering module 114. The recommendation module 110 is configured to select a recommended action for an epoch based on a current state and a transition model. Each state is based on information that can include one or more previous user actions and one or more previous recommended actions from the sequential recommendation system 104 over a session between the user device 102 and the sequential recommendation system 104.

The transition model includes transition probabilities that are used for selecting a recommended action based on the current state. The transition probabilities comprise probabilities between each pair of available states for each available recommended action. In other words, the transition probability of a new state s′ given a current state s and recommended action a can be reflected asp (s′|s, a). In some configurations, the recommendation module 110 uses Markov decision processes (MDP) employing MDP-based transition probabilities.

Conventionally, active data provides information from which a transition model can be built. However, an accurate transition model requires a large amount of active data that is often not available, for instance, for newly deployed recommendation systems in which information regarding recommended actions is minimal or nonexistent. As will be described in further detail below, the sequential recommendation system 104 leverages passive data 120 to expedite the learning process.

The transition model update module 112 generally operates to generate transition probabilities using passive data 120 and active data 122 (stored in datastore 118). The passive data 120 can include a collection of historical user actions taken without recommended actions from the sequential recommendation system 104. For instance, if the sequential recommendation system 104 is being trained to recommend tutorials for a software application, the passive data 120 could include historical information regarding sequences of tutorials viewed by users in the absence of any recommendations. The transition model update module 112 can take the passive data and construct, for instance, n-grams to predict the impact of next recommended actions given n-history of actions. The transition model update module 112 is deployed incrementally where at each epoch it learns transition probabilities (e.g., parameterized MDP transition probabilities) by using a passive model from the passive data 120 as a prior and using active data 122 that is captured at each epoch to update the prior.

The passive data 120 provides information to determine the probability of a new state s′ given a current state s, which can be reflected as p (s′|s). However, as noted above, the transition model used by the recommendation module 110 requires transition probabilities that reflect the probability of new states given current states and recommended actions—i.e., p (s′|s, a). In the recommendation context, where a represents a recommended action, focus can be placed on a subclass of relationships between p (s′|s, a) and p (s′|s). A linking function provides a bridge between the passive data and the transition probabilities. In other words, the linking function provides for the difference between p (s′|s) provided by the passive data and p (s′|s, a) required for transition probabilities. The linking function f:S×A×S×[0,1]→ [symbol] can be defined as:

f(s, a, s′, p(s′|s)) [symbol] p(s′|s, a)−p(s′|s)

The linking function employs currently available active data 122 to generate parameters that can be used with the passive data 120 to calculate transition probabilities. The active data 122 includes information regarding recommended actions provided by the sequential recommendation system 104 and the states (i.e., previous and new) associated with each recommended action. At each epoch in which the sequential recommendation system 104 provides a recommended action, the active data 122 is updated, and new transition probabilities can be calculated by the transition model update module 112 using new parameters generated from the updated active data 122. The parameterization gets finer at each epoch as more and more active data 122 becomes available, thereby improving the transition probabilities and recommendations.

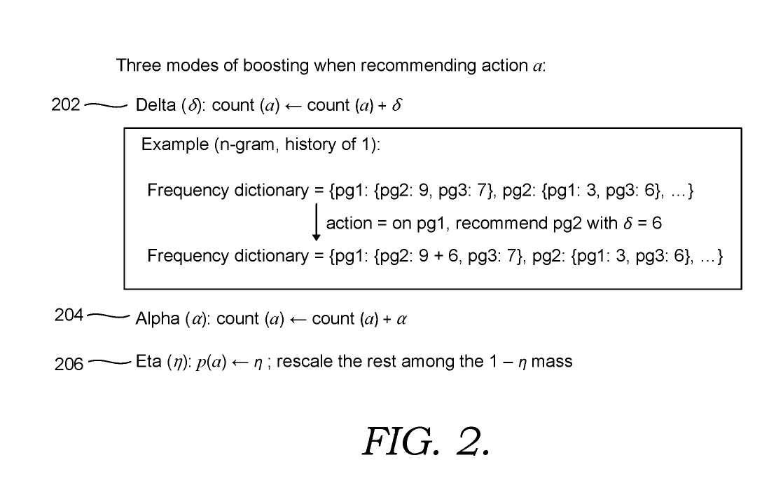

By way of example only and not limitation, FIG. 2 presents three families of linking functions to derive parameter values from the currently available active data 122: delta 202, alpha 204, and eta 206. Delta 202 and alpha 206 are linking functions based on n-gram models that boost the count additively and multiplicatively, respectively. The count (a) shown in FIG. 2 is based on the number of times an action a is observed in the active data 122. Eta 208 is a linking function that sets the probability of a user action given that action is recommended to be a constant eta and redistributes the probability of other actions by the same scale.

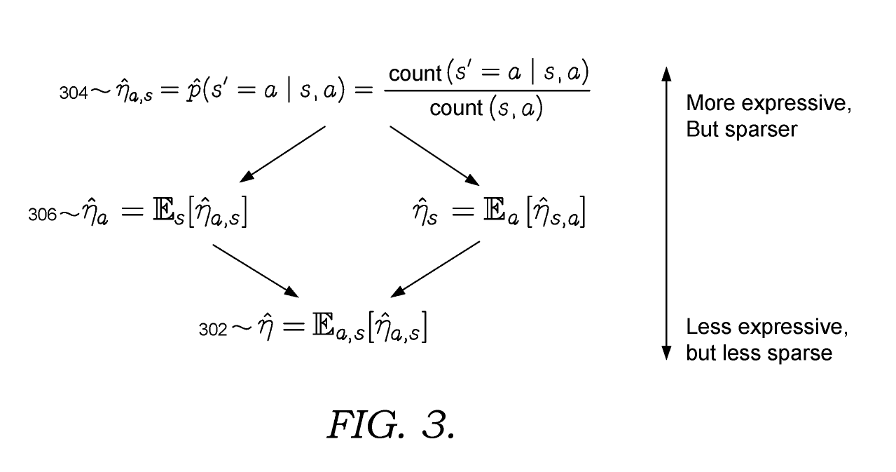

The determination of parameters at each epoch can balance model expressiveness and data availability. FIG. 3 illustrates different approaches that can be taken using the maximum likelihood principle. At one extreme (represented at 302), the model maintains only one global parameter (here, a global eta) that is used for all combinations of states and actions. This certainly has a model bias, but it has less variance due to an abundance of data. At the other extreme (represented at 304), a separate parameter value is provided for each action-state pair. This is very expressive, but suffers from data sparsity. Between these two extremes (represented at 306), a parameter can be provided that is dependent on state only or action only.

In accordance with some implementations, a clustering approach is employed by the clustering module 114 that makes a smooth trade-off between the two extremes illustrated in FIG. 3. The clustering approach determines a preliminary parameter value for each of a number of possible states based on the currently available active data 122. States are then clustered together based on the preliminary parameter values—i.e., states with similar preliminary parameter values are grouped together in each of the clusters. A shared parameter value is then derived for each cluster based on the preliminary parameter values for states in each cluster. For instance, the shared parameter value for a cluster could be the mean or median of the preliminary parameter values of states in the cluster. The shared parameter value derived for each cluster is then assigned to each the states grouped in the cluster.

The clustering of states in this manner can be controlled to balance model expressiveness with data availability. Initially, when limited active data is available to the sequential recommendation system 104, fewer clusters with a larger number of states included can be used to offset the data sparsity. As more active data is gathered over time by the sequential recommendation system 104, more clusters with fewer states included can be used to increase model expressiveness. In some embodiments, as more active data is gathered, the clustering can be performed by splitting previous clusters into smaller clusters.

In some configurations, confidence values are calculated for parameters, and the confidence values can be used to control clustering. More particularly, clusters are generated such that the confidence values associated with parameter values satisfy a threshold level of confidence.

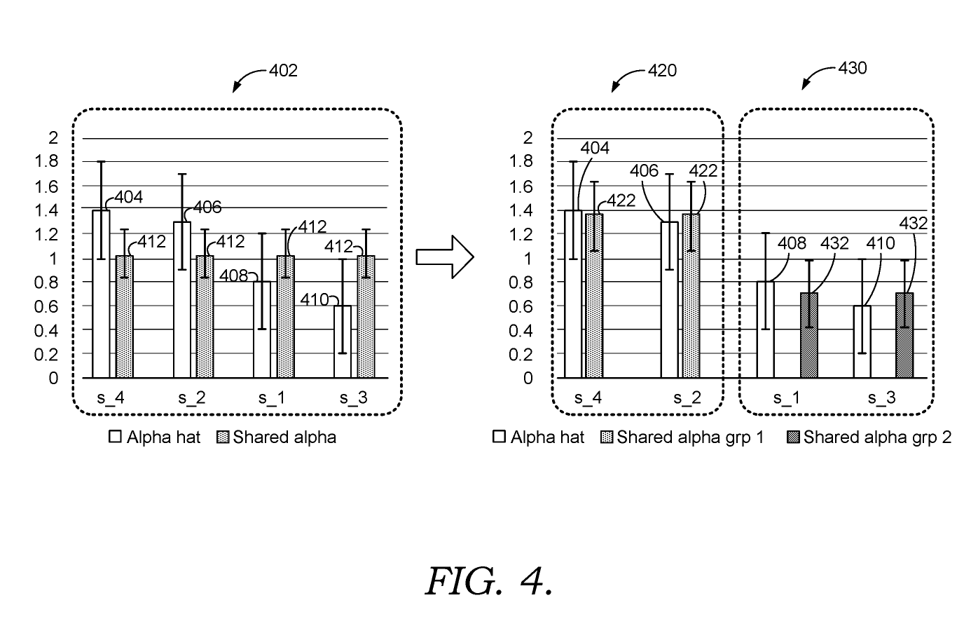

An example of this clustering approach is illustrated in FIG. 4. Initially, four states (s_1 through s_4) are grouped together in a cluster 402. Preliminary parameter value 404 has been determined for state s_4; preliminary parameter value 406 has been determined for state s_2; preliminary parameter value 408 has been determined for state s_1; and preliminary parameter value 410 has been determined for state s_3. Additionally, a shared parameter value 412 has been determined for the cluster 402 based on the preliminary parameter values 404, 406, 408, and 410. If this clustering is chosen, the shared parameter value 412 would be used for each of the four states, s_1 through s_4.

FIG. 4 also illustrates splitting the cluster 402 into two clusters 420 and 430 based on the preliminary parameter values 404, 406, 408, and 410. The first cluster 420 includes states s_4 and s_2, and a shared parameter value 422 has been determined based on the preliminary parameter values 404 and 406. The second cluster 430 includes states s_1 and s_3, and a shared parameter value 432 has been determined based on the preliminary parameter values 408 and 410. If this clustering is chosen, the shared parameter value 422 would be used for each of the two states in the first cluster 420, s_4 and s_2, and the shared parameter value 432 would be used for each of the two states in the second cluster 430, s_1 and s_3.

As noted above, a confidence value (e.g., a confidence interval) can be computed for each parameter value that facilitates clustering. For instance, FIG. 4 shows a confidence bar with each of the preliminary parameter values 404, 406, 408, 410 and each of the shared parameter values 412, 422, 432. The confidence bars for the preliminary parameter values 404, 406, 408, 410 are longer illustrating lower confidence in those parameter values as less data is available to calculate each of those parameter values. The confidence bars for the shared parameter values 412, 422, 432 are shorter since more data is available to calculate each of those parameter values due to the clustering. As noted above, some configurations employ confidence values to determine clusters by ensuring that the clusters provide parameter values with confidence values that satisfy a threshold level of confidence. For instance, the clustering provided by the clusters 420 and 430 would be selected over the cluster 402 to provide more model expressiveness if the confidence values associated with the shared parameter values 422 and 432 provide sufficient confidence (e.g., satisfy a threshold confidence value).

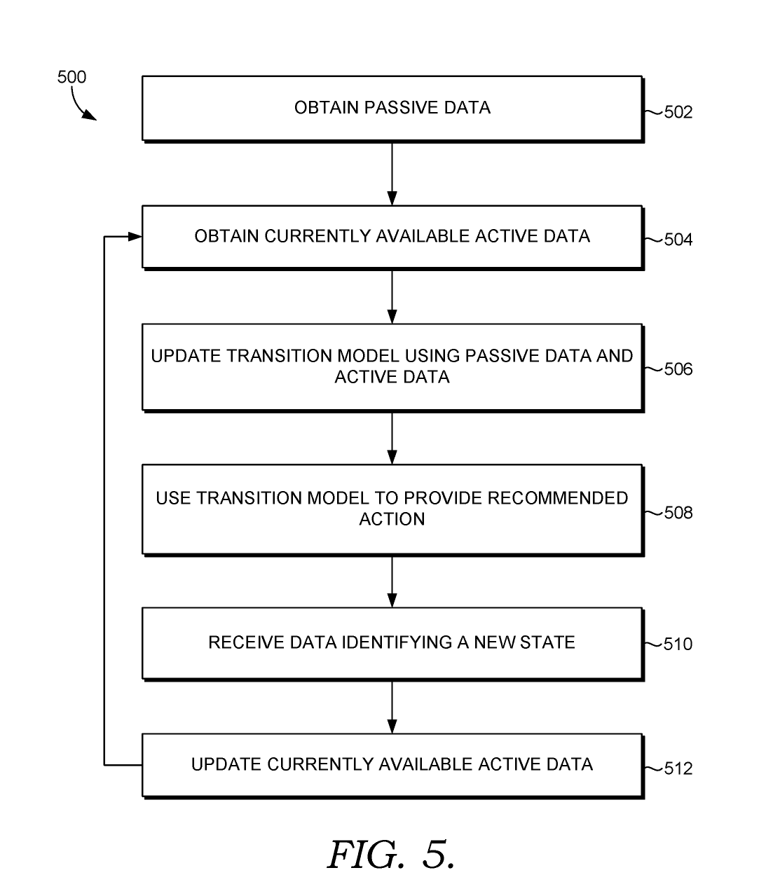

Referring now to FIG. 5, a flow diagram is provided illustrating a method 500 for using passive data when training a learning agent to provide recommended actions. Each block of the method 500 and any other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. The method 500 may be performed, for instance, by the recommendation module 110 and transition model update module 112 of FIG. 1.

Initially, as shown at block 502, passive data is obtained. The passive data includes information regarding sequences of user actions without recommendations from a recommendation system. The passive data can be data collected, for instance, before a recommendation system was developed and/or used. In some configurations, the passive data includes information regarding a sequence of states based on the path of user actions followed by each user.

Currently available active data is then obtained, as shown at block 504. The active data is collected after the recommendation system is initiated and includes recommended actions previously provided by the recommendation system and state information associated with each recommended action. Generally, the active data includes sequences of user actions similar to the passive data but also identifies the recommended actions provided by the recommendation system at each time a user action was taken. In some cases, the active data can also include information regarding rewards provided at each epoch.

As shown at block 506, a transition model of the recommendation system is updated using the passive data and the currently available active data. As previously discussed, the transition model provides transition probabilities between pairs of states for each of a number of available recommended actions. The transition probabilities are generated from the passive data and at least one parameter derived from the currently available passive data. As discussed above, some embodiments use MDP to generate the transitions probabilities with a linking function to transition between the passive data and the MDP probabilities.

The transition model is used to select a recommended action based on the current state, as shown at block 508. The recommended action is selected in an effort to learn an optimal policy that dictates what action should be recommended given different user states in order to maximize the overall rewards for a recommendation session. After providing the recommendation action to a user device, data is received to identify a new state, as shown at block 510. This data may include, for instance, an action selected by the user in response to the recommended action. The currently available active data is also updated based on the recommended action and the previous state and new state, as shown in block 512. The process of: updating the transition model from available active data, providing a recommended action, and updating the active data from blocks 504-512 is repeated for each epoch of interaction between a user device and the recommendation system.

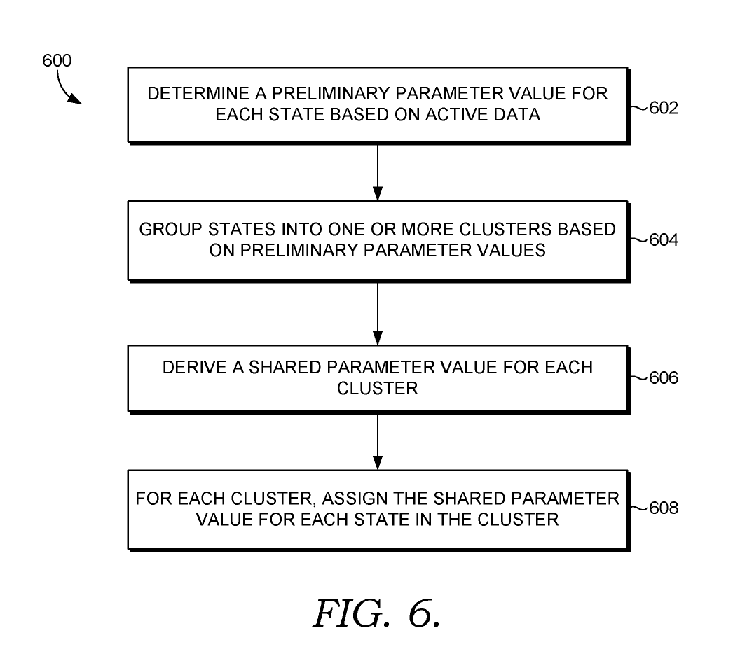

FIG. 6 provides a flow diagram showing a method 600 for using a clustering approach to derive parameters used to generate transition probabilities. As shown at block 602, a preliminary parameter value is determined for each of a number of available states based on currently available active data. The parameter values can be determined, for instance, using a linking function as discussed hereinabove.

The states are grouped into one or more clusters based on the preliminary parameter values, as shown at block 604. A shared parameter value is then generated for each cluster, as shown at block 606. The shared parameter value for a cluster can comprise, for instance, a mean or median value based on the preliminary parameter values of states in the cluster. For each cluster, the shared parameter derived for the cluster is assigned to each state included in that cluster, as shown at block 608. Those parameters can then be employed in deriving transition probabilities as discussed hereinabove.

As noted above, in some configurations, the clustering is performed based on confidence values determined for parameter values. In particular, clusters are selected to ensure that the confidence values satisfy a threshold level of confidence. As more active data is selected, more clusters with fewer states can be generated with sufficient confidence to increase model expressiveness. In some cases, the clustering is performed by splitting previously formed clusters when the threshold level of confidence can be satisfied by the new clusters formed from the splitting.

Having described implementations of the present disclosure, an exemplary operating environment in which embodiments of the present invention may be implemented is described below in order to provide a general context for various aspects of the present disclosure. Referring to FIG. 7 in particular, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion.

The subject matter of the present invention is described with specificity herein to meet statutory requirements. However, the description itself is not intended to limit the scope of this patent. Rather, the inventors have contemplated that the claimed subject matter also might be embodied in other ways, to include different steps or combinations of steps similar to the ones described in this document, in conjunction with other present and/or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As described above, implementations of the present disclosure generally relate to bootstrapping sequential recommendation systems from passive data. Embodiments of the present invention have been described in relation to particular aspects, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objectives set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
obtaining passive data comprising sequences of user actions without recommended actions from a recommendation system; and
deploying a learning agent of the recommendation system to iteratively provide recommended actions over epochs, each epoch including a new state in response to a recommended action selected based on a current state, wherein transition probabilities used by the learning agent to select recommended actions are updated at each epoch using the passive data and at least one parameter value derived from active data from previous epochs, the active data for each epoch comprising information identifying the new state, the recommended action, and the current state for that epoch.

2. The one or more computer storage media of claim 1, wherein the recommendation system comprises a Markov decision process-based recommendation system.

3. The one or more computer storage media of claim 1, wherein the transition probabilities comprise probabilities between each pair of a plurality of states for each of a plurality of recommended actions.

4. The one or more computer storage media of claim 1, wherein the transition probabilities are updated using maximum likelihood principle.

5. The one or more computer storage media of claim 1, wherein the at least one parameter value is derived from the active data using an n-gram model.

6. The one or more computer storage media of claim 1, wherein the at least one parameter value is derived at each epoch using a clustering algorithm.

7. The one or more computer storage media of claim 6, wherein the clustering algorithm comprises:
determining a preliminary parameter value for each of a plurality of states based on the active data;
grouping states into one or more clusters based on the preliminary parameter value for each state;
deriving a shared parameter value for each cluster based on the preliminary parameter value for each state in the cluster; and
assigning the shared parameter value for each cluster to each state grouped in the cluster.

8. The one or more computer storage media of claim 7, wherein the states are grouped into the one or more clusters based on confidence values for the shared parameter values for the clusters.

9. A computer-implemented method of training a learning agent of a recommendation system to provide recommended actions, the method comprising:
obtaining passive data comprising sequences of user actions without recommended actions from the recommendation system; and
training the learning agent of the recommendation system to provide recommended actions by iteratively:
obtaining currently available active data including recommended actions previously provided by the recommendation system and associated state information;
updating a transition model of the recommendation system using the passive data and the active data, the transition model providing transition probabilities between each pair of a plurality of states for each of a plurality of recommended actions, the transition probabilities being generated from the passive data and at least one parameter derived from the currently available active data;
using the transition model to provide a recommended action for a current state and receiving data identifying a new state; and
updating the currently available active data based on the current state, the new state, and the recommended action.

10. The method of claim 9, wherein the transition model of the recommendation system is generated using Markov decision processes.

11. The method of claim 9, wherein the transition probabilities are updated using maximum likelihood principle.

12. The method of claim 9, wherein the transition probabilities are derived from the active data using an n-gram model.

13. The method of claim 9, wherein the transition probabilities are derived using a clustering algorithm.

14. The method of claim 13, wherein the clustering algorithm comprises:
determining a preliminary parameter value for each of a plurality of states based on the active data;
grouping states into one or more clusters based on the preliminary parameter value for each state;
deriving a shared parameter value for each cluster from the preliminary parameter value for each state in the cluster; and
assigning the shared parameter value for each cluster to each state grouped in the cluster.

15. The method of claim 14, wherein the states are grouped into the one or more clusters based on confidence values for the shared parameter values for the clusters.

16. A computer system comprising:
means for training a learning agent of a recommendation system using transition probabilities derived from passive data and at least one parameter derived from active data, the passive data comprising sequences of user actions without recommended actions from the recommendation system, the active data comprising recommended actions previously provided by the recommendation system and associated state information; and
means for deriving the at least one parameter from the active data available at each epoch in which the recommendation system provides a recommendation based on a current state.

17. The system of claim 16, wherein the transition probabilities comprise probabilities between each pair of a plurality of states for each of a plurality of recommended actions.

18. The system of claim 16, wherein the at least one parameter value is derived at each epoch using a clustering algorithm.

19. The method of claim 18, wherein the clustering algorithm comprises:
determining a preliminary parameter value for each of a plurality of states based on the active data;
grouping states into one or more clusters based on the preliminary parameter value for each state;
deriving a shared parameter value for each cluster from the preliminary parameter value for each state in the cluster; and
assigning the shared parameter value for each cluster to each state grouped in the cluster.

20. The system of claim 19, wherein the states are grouped into the one or more clusters based on confidence values for the shared parameter values for the clusters.
